(19) United States
(12) Patent Application Publication
(10) Pub. No.: US 2014/0287975 A1
(43) Pub. Date: Sep. 25, 2014

(54) POST-ADDED BUILDER COMPOSITION

(71) Applicant: David Kennedy, Hoffman Estates, IL (US)

(72) Inventor: David Kennedy, Hoffman Estates, IL (US)

(73) Assignee: AMCOL INTERNATIONAL CORPORATION, Hoffman Estates, IL (US)

(21) Appl. No.: 13/820,766

(22) PCT Filed: Oct. 24, 2012
(86) PCT No.: PCT/US12/61580

§ 371 Date: Mar. 5, 2013

Related U.S. Application Data
(60) Provisional application No. 61/555,251, filed on Nov. 3, 2011.

(51) Int. Cl. C11D 17/06

(52) U.S. Cl. CPC C11D 17/065
USPC 510/349

(57) ABSTRACT

A builder that is a post-manufacture addition to detergent compositions includes a total soluble salt content of about 70 wt. % to about 90 wt. %, wherein about 40 wt. % to about 90 wt. % of the soluble salts are in the form of an alkali carbonate; about 2 wt. % to about 12 wt. % polycarboxylate co-builder; and about 2 wt. % to about 12 wt. % water for solubility and bulk density control. The builder will be added to a detergent (active surfactant) composition in an amount of about 5 wt. % to about 40 wt. %, preferably about 10 wt. % to about 30 wt. %, more preferably about 15 wt. % to about 25 wt. %, and most preferably about 20 wt. % of the detergent composition based on the total weight of detergent and builder. Generally, a higher percentage of builder composition achieves better results when the wash water is harder (contains higher levels of calcium and/or magnesium, e.g. 400 ppm calcium carbonate).

### CROSS-REFERENCE TO RELATED APPLICATION

The benefit under 35 U.S.C. §119(e) of of U.S. Provisional Patent Application No. 61/555,251 filed Nov. 3, 2011, is hereby claimed and the entire disclosure of which is incorporated herein by reference in its entirety.

### FIELD

The present invention is directed to a co-granulated detergent builder composition that is phosphate-free and provides surprisingly low fabric encrustation when incorporated as a post-manufacture addition, to the detergent composition.

### BACKGROUND AND PRIOR ART

Builders in detergent compositions supplement and enhance the cleaning effect of an active surfactant present in the composition. Such builders improve the cleaning and whitening power of the detergent composition, for instance, by the sequestration or precipitation of hardness caused by metal ions, such as calcium and magnesium; peptization of soil agglomerates; and neutralization of acid soil. Builders are important not only for their effect in improving the cleaning and whitening ability of active surfactants in detergent compositions, but also because they allow for a reduction in the amount of the surfactant used in the composition, the surfactant being generally much more costly than the builder.

As acknowledged in U.S. Pat. No. 5,977,047, “other mechanisms by which builders improve the cleaning power of detergent compositions are probably present but are less well understood”. The mechanism involved in providing lower fabric encrustation by post-add builder addition, as separate builder particles containing no anionic and/or non-ionic detergent surfactant contained in the builder particles, to a detergent composition, as described herein, falls into the less understood mechanisms. It is theorized that since the builder is provided by separate powder or granular particles, containing no anionic and/or non-ionic detergent surfactant, the builder components are more effectively solubilized, together with the solubilization of the separate active detergent particles, and by a mechanism that presently is not understood, results in less fabric encrustation.

Sodium tripolyphosphate (STPP) is very effective in sequestering calcium and magnesium ions without precipitating them. However phosphorus-containing builders have been found to cause a serious problem of eutrophication of lakes, rivers and streams when present in detergent compositions resulting in the passage of laws in several states mandating a drastic reduction in their use. While the use of soluble alkaline carbonate builders in amounts up to about 90 wt. % do not cause eutrophication, they result in the unrelated problem of fabric encrustation caused by the precipitation of calcium and magnesium carbonates which deposit on the fiber surfaces of fabrics, causing the fabric to have a stiff hand feel and giving colored fabrics a faded appearance. (See U.S. Pat. No. 5,552,078.)

Polymeric polycarboxylates such as polyacrylates are also known in the detergent art as effective sequestering and dispersing agents as well as crystal growth inhibitors. However, such polycarboxylates, together with the water-soluble alkaline carbonate builders, have resulted in detergent compositions that leave significantly more fabric encrustation than STPP.

Others have attempted to formulate builders for detergent compositions that have fast water-solubility in cold water (e.g., 20° C.) and a high alkaline carbonate content, together with a polycarboxylate co-builder, but have found it necessary to add a phosphorous-containing sequestering agent, or additional magnesium (thereby increasing the hardness of the wash water) for the purpose of lowering the amount of fabric encrustation that is common to builders rich in alkaline carbonate(s) (see U.S. Pat. Nos. 5,552,078 and 5,431,836). The detergent compositions described herein are phosphate-free and contain no added calcium or magnesium, leaving the wash water softer for more effective cleaning of fabrics.

The detergent compositions containing the builder compositions described herein are phosphate-free, have unexpectedly fast, complete solubility in cold water, and have unexpectedly low levels of fabric encrustation in any wash water, particularly wash water having high levels of calcium and/or magnesium, e.g. 400 ppm calcium carbonate.

### SUMMARY

In accordance with the compositions and methods described herein, a phosphate-free powdered or granular laundry detergent composition, contains a completely water-soluble builder composition as a post-manufactured laundry detergent addition. The builder added to the completed laundry detergent is added as a co-granular that has been found to have an exceptionally high dissolution rate at low temperature; has an unexpectedly lower encrustation than STPP on terry cotton fabric, particularly in high water hardness; and provides equivalent detergency and soil re-deposition to STPP builder. The builder is a granule formed by co-granulating a powder blend of water-soluble salts and an aqueous solution of a polycarboxylate, under high shear, and thereafter the co-granule is dried, e.g., in a fluidized bed dryer, to a desired moisture content of about 2 wt. % to about 12 wt. % to obtain a desired bulk density for compatibility with powdered or granular detergents of varying bulk densities, e.g., about 0.55 g/L to about 1.1 g/L.

### DETAILED DESCRIPTION

The detergent builder compositions described herein are provided for post-addition, added to a manufactured active surfactant (detergent) composition after powdering or granulation of the active surfactant, and may include other additives, such as bleaching agents, enzymes and other known detergent additives.

### Active Surfactant

The builder compositions described herein are added to an active surfactant component present in a powdered or granular laundry detergent composition. The active surfactant(s) in the detergent composition may consist of one or more of many suitable synthetic detergent active compounds which are commercially available and described in the literature, for example, in “Surface Active Agents and Detergents,” Volumes 1 and 2 by Schwartz, Perry and Berch, hereby incorporated by reference. Several detergents and active surfactants are also described in, for example, U.S. Pat. Nos. 3,957,695; 3,865,754; 3,932,316 and 4,009,114, all of which are hereby incorporated by reference. In general, the powdered or granular detergent composition that is mixed with the builder compositions described herein may include a synthetic anionic, nonionic, amphoteric or zwitterionic detergent active compound, or mixtures of two or more of such compounds.

Preferably, the laundry detergent compositions that the builder is added to, post detergent manufacture, contain at least one anionic or nonionic surfactant, and, may include a mixture of both types of surfactant.

The contemplated water soluble anionic detergent surfactants are the alkali metal (such as sodium and potassium) salts of the higher linear alkyl benzene sulfonates and the alkali metal salts of sulfated ethoxylated and unethoxylated fatty alcohols, and ethoxylated alkyl phenols. The particular salt will be suitably selected depending upon the particular formulation and the proportions therein.

The sodium alkybenzenesulfonate surfactant (LAS), if used in the detergent compositions, preferably has a straight chain alkyl radical of average length of about 11 to 13 carbon atoms.

Specific sulfated surfactants which can be used in the detergent compositions include sulfated ethoxylated and unethoxylated fatty alcohols, preferably linear primary or secondary monohydric alcohols with C₁₀-C₁₈, preferably C₁₂-C₁₆, alkyl groups and, if ethoxylated, on average about 1-15, preferably 3-12 moles of ethylene oxide (EO) per mole of alcohol, and sulfated ethoxylated alkylphenols with C₈-C₁₆ alkyl groups, preferably C₈-C₉ alkyl groups, and on average from 4-12 moles of EO per mole of alkyl phenol.

The preferred class of anionic surfactants are the sulfated ethoxylated linear alcohols, such as the C₁₂-C₁₆ alcohols ethoxylated with an average of from about 1 to about 12 moles of ethylene oxide per mole of alcohol. A most preferred sulfated ethoxylated detergent is made by sulfating a C₁₂-C₁₅ alcohol ethoxylated with 3 moles of ethylene oxide per mole'of alcohol.

Specific nonionic surfactants which can be used in the detergent compositions include ethoxylated fatty alcohols, preferably linear primary or secondary monohydric alcohols with C₁₀- C₁₈, preferably C₁₂-C₁₆, alkyl groups and on average about 1-15, preferably 3-12 moles of ethylene oxide (EO) per mole of alcohol, and ethoxylated alkylphenols with C₈-C₁₆ alkyl groups, preferably C₈-C₉ alkyl groups, and on average about 4-12 moles of EO per mole of alkyl phenol.

The preferred class of nonionic surfactants are the ethoxylated linear alcohols, such as the C₁₂-C₁₆ alcohols ethoxylated with an average of from about 1 to about 12 moles of ethylene oxide per mole of alcohol. A most preferred nonionic detergent is a C₁₂-C₁₅ alcohol ethoxylated with 3 moles of ethylene oxide per mole of alcohol.

Mixtures of the foregoing synthetic detergent type of surfactants, e.g., of anionic and nonionic, or of different specific anionic or nonionic surfactants, may be used to modify the detergency, sudsing characteristics, and other properties of the detergent composition. For example, a mixture of different fatty alcohols of 12 to 15 carbon atoms may be ethoxylated, directly sulfated, or sulfated after ethoxylation, a fatty alcohol may be partially ethoxylated and sulfated, or an ethoxylated fatty acid may be partially sulfated to yield a mixture of different anionic and nonionic surfactants or different specific anionic or nonionic surfactants.

The total active surfactant in the detergent compositions containing the builder, described infra, may be in the range, for example, of about 5 to 24 wt. %, preferably about 5 to 15 wt. % and most preferably about 8 to 12 wt. %. If the active surfactant consists of a combination of anionic and nonionic surfactants, then the anionic surfactant can be present in the range, for example, of about 4 to 16 wt. %, preferably about 5 to 10 wt. %, and the nonionic surfactant can be present in the range, for example, of about 2 to 8 wt. %, preferably about 3 to 5 wt. %.

### Builder

The builder that is a post-manufacture addition to detergent compositions includes a total soluble salt content of about 70 wt. % to about 90 wt. %, wherein about 40 wt. % to about 90 wt. % of the soluble salts are in the form of an alkali carbonate; about 2 wt. % to about 12 wt. % polycarboxylate co-builder; and about 2 wt. % to about 12 wt. % water for solubility and bulk density control. The builder will be added to a detergent (active surfactant) composition in an amount of about 5 wt. % to about 40 wt. %, preferably about 10 wt. % to about 30 wt. %, more preferably about 15 wt. % to about 25 wt. %, and most preferably about 20 wt. % of the detergent composition based on the total weight of detergent and builder. Generally, a higher percentage of builder composition achieves better results when the wash water is harder (contains higher levels of calcium and/or magnesium, e.g. 400 ppm calcium carbonate).

The builder composition comprises water soluble salts which may be, for example, an alkali metal carbonate, bicarbonate, sesquicarbonate, citrate, silicate and/or sulphate. Preferably, this salt will be sodium carbonate, and more preferably, a combination of two or more of these compounds.

The water-soluble alkaline carbonate may be, for example, an alkali metal carbonate, bicarbonate or sesquicarbonate, preferably sodium or potassium carbonate, bicarbonate or sesquicarbonate, and most preferably sodium carbonate. A combination of more than one of such compounds may be used, e.g., sodium carbonate and sodium bicarbonate. The total water-soluble alkaline carbonate may be present in an amount, for example, of about 40 to about 90 wt. %, preferably about 50 to about 90 wt. %, based on the total weight of water-soluble salts in the builder composition. If a combination of alkali metal carbonate and bicarbonate is used as the water-soluble carbonate, then the alkali metal carbonate, e.g., sodium carbonate, is preferably used in an amount of about 45 to about 75 wt. % and the alkali metal bicarbonate, e.g., sodium bicarbonate, in an amount of about 0.1 to about 15 wt. %, preferably about 5 wt. % to about 15 wt. %, based on the total weight of water-soluble salts in the builder composition.

The polycarboxylate co-builder may be, for example, a homopolymer or copolymer (consisting of two co-monomers).

Suitable polycarboxylates for this formulation are those which impart a dispersive effect on soil and insoluble materials in the washing solution.

Particularly suitable polycarboxylates are composed of acrylic acid, methacrylic acid, maleic acid, maleic anhydride, itaconic acid, glutamic acid, 2-acrylamido-2-methylpropane, fumaric acid or mesoconic acid.

More suitable polycarboxylates can be a copolymer of two of the above detailed monomers, with preference to one of said monomers being acrylic acid in a molar majority (having a molar concentration greater than any other monomer in the copolymer), and in another embodiment, the molar concentration of acrylic acid in the copolymer is at a level of no less than 50 wt. % of the copolymer. In another embodiment, the copolymer is a polymer of acrylic acid, in a molar majority, and maleic anhydride in a molar minority (having a molar concentration less than any other monomer in the copolymer). In the preferred embodiment, the copolymer contains about 60 mole percent to about 90 mole percent acrylic acid and about 10 mole percent to about 40 mole percent maleic anhydride, more preferably about 70 to about 80 mole percent acrylic acid and about 20 to about 30 mole percent maleic anhydride.

The polymeric polycarboxylate should possess a number average molecular weight of, for example, about 1,000 to 70,000, preferably about 2000 to 20,000, more preferably about 3,000 to about 15,000, even more preferably about 4,000 to about 10,000, and most preferably about 5,000 to about 7,000. To ensure high water solubility, the polycarboxylate should be partially or fully neutralized.

In addition to the above, the polymer solution should be of appropriately high viscosity, for example, having a Brookfield viscosity of at least 400 cPs in an aqueous polymer solution containing 45 wt % polymer at ambient temperature.

### Manufacture

The builder can be manufactured by a high shear agglomeration process whereby a powder blend of water soluble salts is agglomerated using an aqueous solution of the polycarboxylate, and subsequently dried in a fluidised bed dryer to an optimum moisture content, in the range of about 2 wt. % to about 12 wt. %, based on the total weight of the co-agglomerated builder, for desired solubility and product bulk density.

### Water-Solubility

The time for complete dissolution, measured until no residue is evident (1% concentration, 20° C., 200 rpm in de-ionised water) for builder granule, is given in Table A below:

TABLE A

| | Time for Dissolution |
|---|---|
| Material | (secs) |
| BUILDER GRANULE | 60 |
| STPP | 120 |

### EXAMPLES 1, 2 AND 3

### Example 1

These examples illustrate the significant improvement in fabric encrustation attained when post-added builder compositions based on the invention are used as a full replacement for STPP as a post-manufacture addition to a powdered or granular detergent composition.

In addition, examples of the efficacy of such post-added builder compositions toward exhibiting parity with STPP in the critical areas of anti-redeposition onto cotton fabric (Example 2), and cleaning ability with respect to the removal of certain stain types (Example 3), are given.

Table B highlights the two formulations used to test builder performance:

TABLE B

| | Encrustation/ | Anti-Soil |
|---|---|---|
| | Stain Removal | Re-Deposition |
| Component | Amount (%) | Amount (%) |
| Bio-Soft ® LABS, Anionic Surfactant | 15.0 | 15.0 |
| Finnfix ® BDA, CMC (Anti-re- | 2.00 | 0.50 |
| deposition aid) | | |
| Silfoam ® SC 1132, Foam Inhibitor | 2.00 | 2.00 |
| Sodium Carbonate | 10.0 | 10.0 |
| Miscellaneous (sulphate, moisture, | Balance | Balance |
| etc.) | | |
| BUILDER | 20.0 | 20.0 |

To assess the effectiveness of the builder compositions, when added to a detergent composition at 20 wt. % based on total weight of detergent and builder, in reducing fabric encrustation, 100% terry cotton swatches were washed twenty times at 40° C. in a tergotometer arrangement at a detergent concentration of 0.50 wt. %. Wash water having a calcium hardness of 400 ppm, expressed as calcium carbonate, and a Ca:Mg ratio of 3:1, was employed. Wash cycle duration of 20 mins with two five minute rinses in hard water, applicable. Encrustation was quantified by incinerating line dried fabric at 950° C. for a minimum of 4.0 hrs in oxygen.

Table C illustrates the results of terry cotton fabric encrustation tests on various formulations which adhere to the compositions described herein.

In Examples 1-4, the following compositional ranges are applicable:

Example 1 is based on composition formulated from the list of carbonate, sesquicarbonate, bicarbonate, citrate, silicate and sulphate, wherein carbonate content is within the range of 70-90% of total soluble salt content

Example 2 contains an acrylic/maleic copolymer having a number average molecular weight of 70,000 in place of the preferred acrylic (80 wt. %)/maleic (20 wt. %, as maleic anhydride) polycarboxylate copolymer co-builder having a number average molecular weight of about 5,000 to about 7,000.

Example 3 is based on a builder composition formulated from the list of carbonate, sesquicarbonate, bicarbonate, citrate, silicate and sulphate, wherein the carbonate content is within the range of 40-70% of total soluble salt content and contains an acrylic/maleic copolymer based on 50:50 acrylic acid/maleic anhydride monomer ratio having a number average molecular weight of about 5,000 to about 7,000.

Example 4 is based on composition formulated from the list of carbonate, sesquicarbonate, bicarbonate, citrate, silicate and sulphate, granulated with the preferred polycarboxylate co-builder, wherein the carbonate content lies within the range of 40-70% of total soluble salt content.

Example 5 is based on composition formulated from the list of carbonate, sesquicarbonate, bicarbonate, citrate, silicate and sulphate, wherein the carbonate content is within the range of 70-90% of total soluble salt content

All of the above formulations were processed as agglomerates and subsequently dry blended into detergent powder formulations.

Table D shows the comparison on terry cotton ash encrustation when the constituent raw materials of the preferred composition (Example 6) are introduced during detergent manufacture (fully formulated) at the same loading as would be achieved through a post addition route.

TABLE C

| Component | Example 1 | Example 2 | Example 3 | Example 4 | Example 5 | Example 6 |
|---|---|---|---|---|---|---|
| Sodium Carbonate | 65.0 | 40.0 | 40.0 | 40.0 | 65.0 | 40.0 |
| Sodium Bicarbonate | 7.50 | 6.00 | 6.00 | 6.00 | 7.50 | 6.00 |
| Trisodium Citrate Dihydrate | 0.00 | 10.0 | 10.0 | 0.00 | 10.0 | 10.0 |
| Sodium Sulphate | 7.50 | 27.0 | 27.0 | 37.0 | 0.00 | 27.0 |
| Polycarboxylate Co-Builder (80:20) | 12.0 | 0.00 | 0.00 | 10.0 | 10.0 | 10.0 |
| Polycarboxylate Co-Builder (50:50) | 0.00 | 0.00 | 10.0 | 0.00 | 0.00 | 0.00 |
| Polycarboxylate Co-Builder, Mw | 0.00 | 10.0 | 0.00 | 0.00 | 0.00 | 0.00 |
| 70,000 | | | | | | |
| Water | 8.00 | 7.00 | 7.00 | 7.00 | 7.50 | 7.00 |

TABLE D

| Reference | % Fabric Encrustation |
|---|---|
| STPP | 7.10 |
| Example 1 | 3.90 |
| Example 2 | 3.50 |
| Example 3 | 2.80 |
| Example 4 | 2.10 |
| Example 5 | 2.00 |
| BUILDER Constituents of example 6, fully | 1.70 |
| formulated (Pre-Add) | |
| BUILDER GRANULE (Example 6) Post-Add | 1.50 |

As can be seen from Tables C and D, the referenced compositions offers a marked advantage over STPP in the prevention of fabric encrustation on terry cotton cloth in high water hardness, even when the sodium carbonate constituent is employed as a significant portion of the overall builder composition. Surprisingly, the post-addition of the granular builder form to a manufactured detergent, compared to the addition of the same (not co-granulated) builder composition components added during surfactant (detergent) processing achieved a 13% improvement in reducing fabric encrustation.

To measure the anti-redeposition properties of the builder composition described herein, referenced as Example 6 in Table C, relative to STPP, five washes were conducted at 40° C. in a tergotometer arrangement at a detergent concentration of 0.50 wt. %. Wash water having a calcium hardness of 400 ppm, expressed as calcium carbonate and a Ca:Mg ratio of 3:1, was employed. Wash cycle duration of 20 mins with two five minute rinses in hard water, applicable. Three cotton cretonne, bleached woven swatches (3.5″×3.5″), CFT-CN-11, were used per one litre vessel. 0.50 g charge of soil, as described in ASTM D4008-95 (2009), was employed for test. Reflectance readings for test cloths were obtained at three points on fabric surface over a minimum of six thicknesses using a Hunter Colour Labscan XE spectrophotometer equipped with 420 nm UV cut-off filter. Reflectance measurements were taken before and after wash cycles, and recorded as ΔR, which denotes the change in reflectance; i.e., ΔR=(R_{washed}−R_{unwashed}). The lower the reduction in reflectance, the less re-deposition has occurred. Table E shows results obtained when co-agglomerated builder granule was tested as a replacement for STPP in a detergent formulation containing a low level of anti-re-deposition aid, carboxymethylcellulose.

TABLE E

| Reference | R_{washed} | R_{unwashed} | ΔR (R_{washed} − R_{unwashed}) |
|---|---|---|---|
| STPP | 77.0 ± 0.6 | 87.5 ± 0.1 | −10.5 |
| Example 6 | 76.2 ± 0.5 | 87.5 ± 0.1 | −11.3 |

As shown in Table E, the prevention of soil re-deposition is of same order for STPP and Example 6.

Tergotometer tests were used to evaluate the detergency offered by the preferred builder granule composition, Example 6, as a detergent post-manufacture addition, and STPP on certain stain types. Three swatches of stained fabrics referenced in Table E were washed at 40° C. at detergent concentration of 0.50 wt. %. Wash water having a calcium hardness of 250 ppm, expressed as calcium carbonate and a Ca:Mg ratio of 3:1, was employed. Wash time was 30 minutes, with two 5 minute rinse cycles applicable. Reflectance readings were taken at three points on fabric surface on a minimum of six thicknesses. Measurements were taken of the stained swatches before, and after washing using a Hunter Colour LabScan XE spectrophotometer equipped with 420 nm UV cut-off filter. Detergency measured as the change in reflectance, ΔR=(R_{washed}−R_{unwashed}), with higher ΔR indicating better builder performance.

TABLE F

| | | CFT-C-S-127 | | CFT-C-S-06 |
|---|---|---|---|---|
| | | (Potato | | (Salad |
| | | Starch, | | Dressing |
| | CFT-C-S-42 | Coloured, | CFT-C-S-08 | with Natural |
| | (Clay) | Aged) | (Grass) | Black) |
| Material | ΔR (Measure of Detergency) | | | |
| STPP | 2.6 | 3.2 | 6.6 | 5.4 |
| Example 6 | 4.8 | 3.2 | 7.1 | 5.5 |

As shown in Table F, compared to STPP, the preferred builder granule achieved an 85% better clay stain removal, an 8% better stain removal on grass stains and exhibited parity toward stain removal on salad dressing.

Fabric encrustation tests were conducted like those described with reference to tables C and D, using 100% terry cotton swatches washed twenty times at 40° C. in three different water hardnesses, at a detergent concentration of 0.50 wt. %. Three wash waters having calcium hardnesses of 110 ppm, 250 ppm, and 400ppm, expressed as calcium carbonate, and a Ca:Mg ratio of 3:1, were employed. Wash cycle duration of 20 mins with two five minute rinses in hard water, applicable. Encrustation was quantified by incinerating line dried fabric at 950° C. for a minimum of 4.0 hrs in oxygen. The anionic detergent formulation (LAS) and the combined anionic/nonionic detergent formulations are shown in Table G.

TABLE G

| | | | Power Detergent | |
|---|---|---|---|---|
| | Powder Detergent | | Composition Based on | |
| | Composition Based on | | Anionic/Nonionic | |
| | Anionic Surfactant | | Surfactants | |
| | Post Add- | Fully | Post Add- | Fully |
| | Builder | Formu- | Builder | Formu- |
| | Based | lated | Based | lated |
| Detergent | Detergent | Detergent | Detergent | Detergent |
| Component | (%) | (%) | (%) | (%) |
| Linear C₁₂₋₁₈ | 15.0 | 15.0 | 8.00 | 8.00 |
| Alkylbenzene | | | | |
| Sulphonate (LAS) | | | | |
| C₁₃₋₁₅ Fatty Alcohol | Nil | Nil | 3.00 | 3.00 |
| Ethoxylate (EO = 7) | | | | |
| Sodium Silicate, | Nil | Nil | 3.00 | 3.00 |
| MR 2.00 | | | | |
| CMC, Anti- | 2.00 | 2.00 | 0.50 | 0.50 |
| Redeposition Aid | | | | |
| Suds Suppressor, | 2.00 | 2.00 | 0.50 | 0.50 |
| Polysiloxane | | | | |
| Sodium Carbonate | 10.0 | 18.0 | 12.0 | 20.0 |
| Sodium Bicarbonate | Nil | 1.20 | Nil | 1.20 |
| Sodium Citrate | Nil | 2.00 | Nil | 2.00 |
| Polycarboxylate Co- | Nil | 2.00 | Nil | 2.00 |
| Builder, (80:20) | | | | |
| Sodium Percarbonate | Nil | Nil | 12.0 | 12.0 |
| Bleach Activator, | Nil | Nil | 3.00 | 3.00 |
| TAED | | | | |
| Post-Add Builder | 20.0 | Nil | 20.0 | Nil |
| Granule (preferred | | | | |
| Composition) | | | | |
| Miscellaneous | Balance | Balance | Balance | Balance |
| (perfumes, | | | | |
| brighteners, | | | | |
| sulphate etc.) | | | | |

The data presented in the following Table H is a summary of % Ash Residue (fabric encrustation) obtained in the same manner as described in the fabric encrustation of Tables B and D, coupling the preferred composition of Example 6, post added, to Zeolite 4A/polycarboxylate and Example 6 FF (the builder components of Example 6 added during detergent manufacture). The, data is presented for both an anionic (LAS) detergent and anionic/nonionic detergent.

TABLE H

| | Addi- | Water | | |
|---|---|---|---|---|
| | tion | Hardness | | |
| | Level | (ppm) | Detergent | % Ash |
| Builder | (%) | [40° C.] | Type | Residue |
| Zeolite 4A/ | 20/4 | 110 | Anionic | 0.77 ± 0.06 |
| polycarboxylate | | | | |
| Zeolite/Acrylic-maleic | 20/4 | 250 | Anionic | 5.79 ± 0.07 |
| copolymer @ 70,000 | 20/4 | 400 | Anionic | 13.43 ± 0.24 |
| MW | | | | |
| Zeolite 4A/ | 20/4 | 110 | Anionic/ | 0.67 ± 0.01 |
| polycarboxylate | | | Non-Ionic | |
| Zeolite/Acrylic-maleic | 20/4 | 250 | Anionic/ | 2.47 ± 0.25 |
| copolymer @ 70,000 | | | Non-Ionic | |
| MW | 20/4 | 400 | Anionic/ | 10.15 ± 0.32 |
| | | | Non-Ionic | |
| Preferred Composition | 20 | 110 | Anionic | 0.27 ± 0.002 |
| of Example 6 Post | 20 | 250 | Anionic | 0.76 ± 0.004 |
| added | 20 | 400 | Anionic | 1.50 ± 0.03 |
| Preferred Composition | 20 | 110 | Anionic/ | 0.34 ± 0.01 |
| of Example 6 Post | | | Non-Ionic | |
| added | 20 | 250 | Anionic/ | 2.20 ± 0.02 |
| | | | Non-Ionic | |
| | 20 | 400 | Anionic/ | 7.92 ± 0.11 |
| | | | No-Ionic | |
| Fully Formulated | N/A | 110 | Anionic | 0.29 ± 0.004 |
| Detergent | N/A | 250 | Anionic | 0.89 ± 0.02 |
| containing same | N/A | 400 | Anionic | 1.70 ± 0.02 |
| builder | | | | |
| components of | | | | |
| Example 6 | | | | |
| Fully Formulated | N/A | 110 | Anionic/ | 0.77 ± 0.02 |
| Detergent | | | Non-Ionic | |
| containing same | N/A | 250 | Anionic/ | 5.47 ± 0.02 |
| builder | | | Non-Ionic | |
| components of | N/A | 400 | Anionic/ | 13.02 ± 0.16 |
| Example 6 | | | Non-Ionic | |

As seen from the data, the post-added builder composition described and claimed herein is far superior to the Zeolite 4A/polycarboxylate builder at every water hardness level tested, and using both anionic and nonionic detergents, particularly at water hardness levels at or above about 200 ppm calcium as calcium carbonate, e.g., about 250 ppm and above. Compared to the builder composition added during detergent manufacture (Fully Formulated), again the post-added builder described herein provides less fabric encrustation at all water hardness levels tested using both anionic and nonionic detergent formulations. The post-added builder formulation provides unexpectedly lower fabric encrustation at water hardness levels at or above about 200 ppm calcium as calcium carbonate, e.g., at a level of about 250 ppm or more calcium as calcium carbonate, using either anionic or nonionic detergents.

1. A co-granulated, phosphate-free detergent builder composition, in particle form, for post addition to a detergent composition, said builder particles having no anionic or non-ionic surfactant contained therein and having an improved dissolution rate at low temperatures and a lower fabric encrustation or redeposition rate when added to a detergent composition containing an anionic and/or non-ionic active detergent surfactant comprising:
an alkali metal water soluble salt selected from the group consisting of carbonate, bicarbonate, sequicarbonate, citrate, sulfate, and combinations thereof in an amount of 40 wt. % to 90 wt. %, based on the total weight of the composition;
a polycarboxylate co-builder, having a number average molecular weight in the range of about 1,000 to about 60,000, in an amount of about 2 wt. % to about 12 wt. %, based on the total weight of the composition; and
water in an amount of about 2 wt. % to about 12 wt. %, based on the total weight of the composition.

2. The detergent builder composition of claim 1, wherein the alkali metal water-soluble salt is a combination of an alkali metal carbonate, in an amount of about 30 wt. % to about 60 wt. %; an alkali metal bicarbonate and/or an alkali metal sequicarbonate in an amount of about 3 wt. % to about 15 wt. %; an alkali metal citrate in an amount of about 5 wt. % to about 29 wt. %; and an alkali metal sulfate and/or alkali metal sulfonate in an amount of about 20 wt. % to about 40 wt. %, based on the total weight of water soluble salts in the builder composition.

3. The detergent builder composition of claim 2 wherein the water-soluble salts, in powder form, are combined with water in an amount of about 2 wt. % to about 12 wt. %, and the polycarboxylate co-builder, in an amount of about 2 wt. % to about 12 wt. %, and sheared together to agglomerate the powdered salts, water and polycarboxylate co-builder into a co-granulated builder composition.

4. The detergent builder composition of claim 1, wherein the polycarboxylate co-builder has a number average molecular weight in the range of about 3,000 to about 20,000.

5. The detergent builder composition of claim 1, wherein the polycarboxylate co-builder has a number average molecular weight in the range of about 4,000 to about 10,000.

6. The detergent builder composition of claim 1, wherein the polycarboxylate co-builder has a number average molecular weight in the range of about 5,000 to about 7,000.

7. The detergent builder composition of claim 1, wherein the polycarboxylate co-builder is a polymer polymerized from one or more monomers selected from the group consisting of acrylic acid, methacrylic acid, maleic acid, maleic anhydride, 2-acrylanido-2-methylpropane, fumaric acid, mesoconic acid, itaconic acid, glutamic acid, mixtures and copolymers thereof.

8. The detergent builder composition of claim 1, wherein the polycarboxylate co-builder is a co-polymer of two or more monomers selected from the group consisting of acrylic acid, methacrylic acid, maleic acid, maleic anhydride, 2-acrylanido-2-methylpropane, fumaric acid, mesoconic acid, itaconic acid, glutamic acid, mixtures thereof.

9. The detergent builder composition of claim 1, wherein the polycarboxylate co-builder is a copolymer of 60 to 90 mole percent acrylic acid and 10 to 40 mole percent maleic acid.

10. The detergent builder composition of claim 1, wherein the polycarboxylate is a copolymer polymerized from a molar majority of acrylic acid and a molar minority of maleic anhydride.

11. The detergent builder composition of claim 1, wherein the polycarboxylate co-builder is a copolymer of acrylic acid and maleic acid wherein the molar percentages of acrylic acid and maleic acid are about 65% to 85% acrylic acid and about 15% to 35% maleic acid.

12. The detergent builder composition of claim 1, wherein the polycarboxylate co-builder is a copolymer of acrylic acid and maleic acid wherein the molar percentages of acrylic acid and maleic acid are about 60% to 90% acrylic acid and about 10% to 40% maleic acid.

13. The detergent builder composition of claim 1, wherein the polycarboxylate co-builder is a copolymer of acrylic acid and maleic acid where in the molar percentages of acrylic acid and maleic acid are about 80% acrylic acid and about 20% maleic acid.

14. The detergent builder composition of claim 1, wherein the water-soluble salt comprises about 40 wt. % to about 95 wt. % alkali metal carbonate; about 5 wt. % to about 10 wt. % alkali metal bicarbonate; about 10 wt. % to about 15 wt. % alkali metal citrate; and about 25 wt. % to about 40 wt. % alkali metal sulfate or alkali metal sulfonate.

15. The detergent builder composition of claim 1, wherein the alkali metal salt is selected from the group consisting of sodium carbonate; sodium bicarbonate; trisodium citrate; sodium sulfate; sodium sulfonate; and combinations thereof.

16. The detergent builder composition of claim 15, wherein the water-soluble salt is a combination of about 30 wt. % to about 60 wt. % sodium carbonate; about 3 wt. % to about 15 wt. % sodium bicarbonate; about 5 wt. % to about 20 wt. % trisodium citrate; and about 20 wt. % to about 40 wt. % sodium sulfate based on the total weight of water-soluble salt in the builder composition.

17. The detergent builder composition of claim 16, wherein the water-soluble salt comprises about 40 wt. % to about 55 wt. % sodium carbonate; about 5 wt. % to about 10 wt. % sodium bicarbonate; about 10 wt. % to about 15 wt. % trisodium citrate; and about 25 wt. % to about 40 wt. % sodium sulfate.

18. The detergent builder composition of claim 1, wherein the polycarboxylate co-builder is a copolymer comprising a molar majority of acrylic acid monomer and a molar minority of one or more co-monomers selected from the group consisting of methacrylic acid, maleic acid, maleic anhydride, 2-acrylanido-2-methylpropane, fumaric acid, mesoconic acid, itaconic acid, glutamic acid, mixtures and copolymers thereof.

19. The detergent builder composition of claim 18 wherein acrylic acid comprises about 70-90 mole % of the copolymer.

20. A method of reducing fabric encrustation and/or increasing stain removal properties of a powdered or granular laundry detergent composition comprising adding to said laundry detergent composition about 5 wt. % to about 40 wt. % of the co-granulated detergent builder composition of claim 1.

21. A method of reducing fabric encrustation during a process of washing fabric comprising washing the fabric in wash water containing a laundry detergent composition that includes, as a post-manufactured additive, about 5 wt. % to about 40 wt. % of the co-granulated detergent builder composition of claim 1.

22. The method of claim 20, wherein the detergent builder composition is added to the laundry detergent composition in an amount of about 10 wt. % to about 30 wt. %, based on the total weight of laundry detergent composition and detergent builder composition.

23. The method of claim 22, wherein the detergent builder composition is added to the laundry detergent composition in an amount of about 15 wt. % to about 25 wt. %, based on the total weight of laundry detergent composition and detergent builder composition.

24. A method of manufacturing a powdered or granular laundry detergent formulation comprising anionic and/or non-ionic detergent active raw materials by drying said detergent active raw materials from an aqueous slurry or by pre-mixing the detergent active raw materials and then agglomerating and drying the raw materials to form a laundry detergent composition; and thereafter, mixing into the dried laundry detergent composition the detergent builder composition of claim 1, to form the laundry detergent formulation.
